(19) United States
(12) Patent Application Publication
(10) Pub. No.: US 2009/0144046 A1
(43) Pub. Date: Jun. 4, 2009

(54) METHOD TO ENCAPSULATE AN OPTION ROM FOR OPERATION IN MULTIPLE FIRMWARE AND PLATFORM ARCHITECTURES

(76) Inventors: Michael A. Rothman, Puyallup, WA (US); Vincent J. Zimmer, Federal Way, WA (US)

Correspondence Address: INTEL CORPORATION;c/o CPA Global, P.O. BOX 52050, MINNEAPOLIS, MN, 55402, US

(21) Appl. No.: 11/864,551

(22) Filed: Sep. 28, 2007

(51) Int. Cl. G06F 9/455

(52) U.S. Cl. 703/27

(57) ABSTRACT

A method and apparatus described herein are for providing a simplified option Read Only Memory (ROM) that is compatible in multiple firmware and platform architectures. Instead of providing multiple option ROM images for every variation of platform architecture and firmware architecture, a single code image is provided along with an interpreter stub. If the default code type of the code image is supported by a platform, then the option ROM is directly launched from the single code image without launching the interpreter stub. However, if a device including the option ROM is inserted in a different variation of platform or firmware architecture that does not support the single code image code type, then the interpreter is launched, which in turn interprets, translates, and/or launches the single code image.

### FIELD

This invention relates to the field of computer systems and, in particular, to modeling devices in computer systems.

### BACKGROUND

Computer system configurations have evolved from pure personal computing uses into a completely new realm of media and entertainment. As a result, numerous different peripheral devices have been designed for computing systems. A few examples of these peripheral devices include graphics accelerator cards for faster video gaming, tuner cards for watching TV, audio cards for better music/sound quality, and networking cards for enabling fast and potentially wireless internet connection. Previously, legacy drivers in basic input/output software (BIOS) were used to handle computer add-in devices. However, as the devices have evolved so has the method of dealing with the greater number and complexity of these devices. In fact, a standard known as Unified Extensible Firmware Interface (UEFI) has been developed to provide a more robust interface between operating systems and platform firmware, as well as provide better boot and runtime service.

As can be readily seen, the number of variations of both platform architecture, such as different processors utilized in systems, and firmware architectures, such as legacy code vs. newly developed code, has greatly increased. As a corollary, the pressure on device manufacturers have increased to ensure a product is compatible with as many of these variations as possible. These manufactures must then create multiple different variations of their product to be compatible with different processor and firmware architectures.

Alternatively, the manufactures may manufacture one device with a larger Read Only Memory (ROM) to support different processor and firmware architectures. To illustrate, FIG. 1 depicts expansion ROM 100 to hold multiple code images. Often these images include different data structures and code, such as initialization code, runtime code, headers, and other runtime code to service an associated device. However, this code is typically compiled binary code for a specific processor/firmware architecture; making the code executable only on that architecture. As illustrated, expansion ROM 100 includes six different code images, i.e. images 105-130, which potentially provide similar functionality for different architectures, such as legacy/EFI 32-bit, legacy/EFI 64-bit, and legacy/EFI IPF architectures. Furthermore, beyond legacy and EFI, some interconnect specifications allow for specific processor executable code, such as x86 code. As the number of architecture variations continue to grow the size and complexity of option ROMs becomes prohibitively large.

### BRIEF DESCRIPTION OF THE DRAWINGS

The present invention is illustrated by way of example and not intended to be limited by the figures of the accompanying drawings.

FIG. 1 illustrates an embodiment of a prior art option ROM.

FIG. 2 illustrates an embodiment of a code image for an option ROM.

FIG. 3 illustrates an embodiment of an option ROM to hold an interpreter stub.

FIG. 4 illustrates an embodiment of a flow diagram for a method of simplifying option ROM storage.

### DETAILED DESCRIPTION

In the following description, numerous specific details are set forth such as examples of specific add-in devices, specific firmware/processor architectures, option ROM information etc. in order to provide a thorough understanding of the present invention. It will be apparent, however, to one skilled in the art that these specific details need not be employed to practice the present invention. In other instances, well known components or methods, such as specific EFI, BIOS, option ROM implementation, specific code, and specific operational details of computer systems, have not been described in detail in order to avoid unnecessarily obscuring the present invention.

The method and apparatus described herein are for providing a simplified option Read Only Memory (ROM) that is compatible in multiple firmware and platform architectures. Specifically, providing a simplified option ROM is primarily discussed in reference to option ROMs on add-in hardware devices. However, the methods and apparatus described herein are not so limited, as they may be implemented on or in association with any integrated circuit device or system, such as cell phones, personal digital assistants, embedded controllers, mobile platforms, desktop platforms, and server platforms, as well as in conjunction with any type of electronic device.

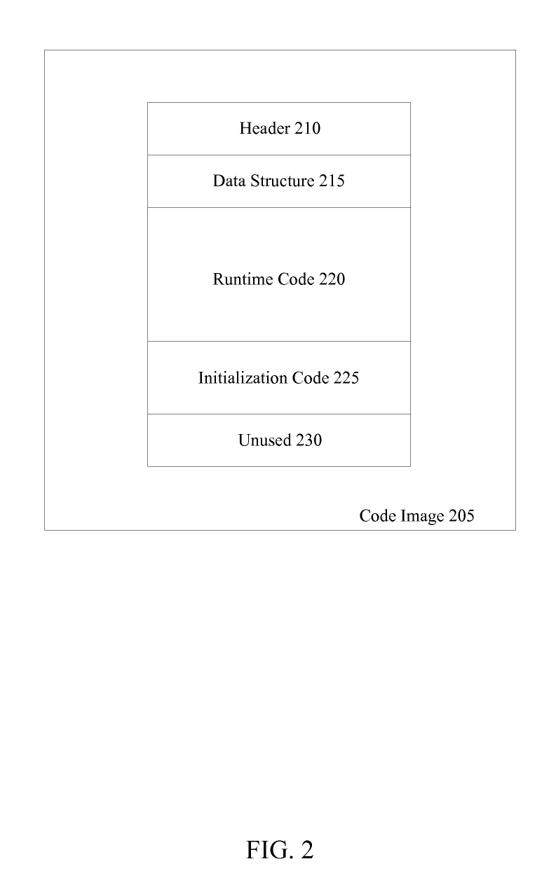

Referring to FIG. 2, an embodiment of a code image for an option ROM is illustrated. In one embodiment, a hardware device includes a plurality of storage elements. Examples of common storage elements include a register, a Read Only Memory (ROM), a volatile memory, a non-volatile memory, and a flash device. A hardware device refers to any integrated circuit device. In one embodiment, a hardware device includes an add-in device for a computer system. Common examples of add-in cards include video cards, tuner cards, accelerator cards, storage cards, interconnect specific cards, audio cards, and network cards. However, in another embodiment, a device includes an integrated circuit either electrically or wirelessly coupled to a computer system.

Typically, a hardware device, such as a peripheral component interconnect (PCI) device, includes multiple configuration registers to hold configuration information about the hardware device. Often the type of configuration information, as well as the format of the configuration information, is defined in a specification to allow multiple device designers to manufacture compatible devices. For example, the registers may hold a device ID, a vendor ID, status information, command information, class information, revision ID, header type, base addresses, line size, subsystem IDs, subsystem vendor IDs, an expansion ROM base address, and other configuration information. For a specific example, the latest revision of the Peripheral Component Interconnect (PCI) specification may be found at http://www.pcisig.com/specifications/.

Here, code image 205 may be held in an original configuration space, such as within an original ROM or group of configuration registers, or held in an expansion device, such as an expansion ROM. In the later embodiment, an expansion base address held in a configuration register indicates the location of the expansion ROM within the device's memory address space. Code image 205 includes any type of configuration information and code/drivers. As illustrated code image 205 includes header 210, data structure 215, runtime code 220, initialization code 225, and unused portion 230.

In one embodiment, data structure 215 includes information about code image 205, such as an image length, a revision level of code/data, a code type, and indicator byte, and reserved sections. Here, the code type indicates which code type code image 205 is capable of being execute on. Examples of code types include processor specific executable code, x86 executable code, open boot interpretive code, Reduced Instruction Set Code (RISC), EFI code, legacy code, legacy IA-32 code, legacy IA-64 code, legacy IPF code, EFI-32 code, EFI-64 code, and EFI-IPF code. Note that in some code type classifications, some of the examples above may be classified in the same code type, such as legacy IA-32, legacy IA-64, and legacy IA IPF within x86 executable code; however, they may be considered distinct code types in response to commonly utilizing different code images to launch option ROMs on their respective architectures.

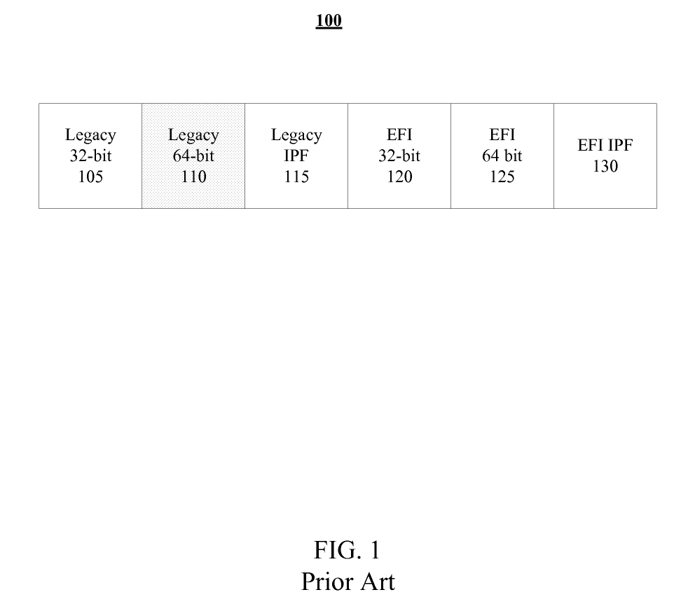

Therefore, code image 205 includes code, when executed, to provide initialization and/or runtime service to the associated hardware device. However, in previous implementations, code image 205 may be compiled for different platform/firmware architectures and held as many different code images, as illustrated in FIG. 1.

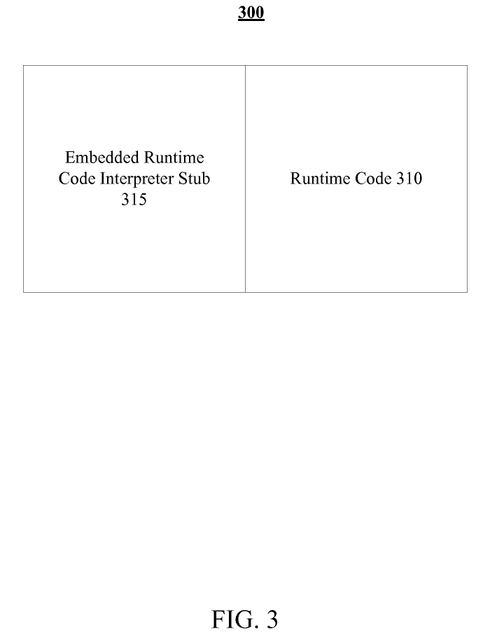

In contrast, FIG. 3 depicts an embodiment of a storage element with an interpreter stub image to support compatibility in multiple firmware and platform architectures. As stated above, common examples of a storage element include a register, a ROM, a non-volatile memory, a volatile memory, and a flash memory device. Here, storage element 300 includes two images: runtime code image 310 and embedded runtime code interpreter stub 315. In one embodiment, runtime code 310 has a first code type. Therefore, if a device including storage element 300 is initialized in a computer system supporting the first code type, then code image 310 may be directly executed.

However, as stated above many processor and firmware architectures may be utilized, which do not support runtime code image 310's code type. As a result, embedded runtime code interpreter stub image 315 is utilized to translate or interpret runtime code 310 to a supported code type. In one embodiment, interpreter stub 315 is capable of interpreting runtime code 310 into a plurality of different code types for a plurality of different architectures. Therefore, it may be determined a second code type is supported by a computer system. As a result, the computer system launches image 315, which when launched/executed, seeks out runtime code image 310 and translates image 310 into the second code type.

To provide an illustrative example, assume runtime code image 310 is an Extensible Firmware Interface (EFI) Byte Code (EBC) code type. Although in another embodiment, runtime code 310 may be compiled into EFI binary; here, runtime code 310 includes byte code capable of being executed by EFI firmware. Therefore, if a hardware device including storage element 300 is added to a computer system supporting EFI, then runtime code 310 is directly launched without executing interpreter stub 315.

However, assume the computer system only supports legacy 32-bit code. Here, the code type for image 310, which may be indicated by a data structure in code image 310, is not supported. In other words, the EBC code type of the runtime image is not supported by the legacy 32-bit platform. As a result, interpreter stub 315 is launched instead of directly launching the unsupported image. In turn, interpreter stub 315 interprets and/or translates image 310 to be executed in the legacy 32-bit computer system. As a simple illustrative example, an operation in code image 310 with an opcode recognized by EFI firmware may be interpreted/translated through stub 315 to a legacy 32 bit opcode recognized by the legacy computer system.

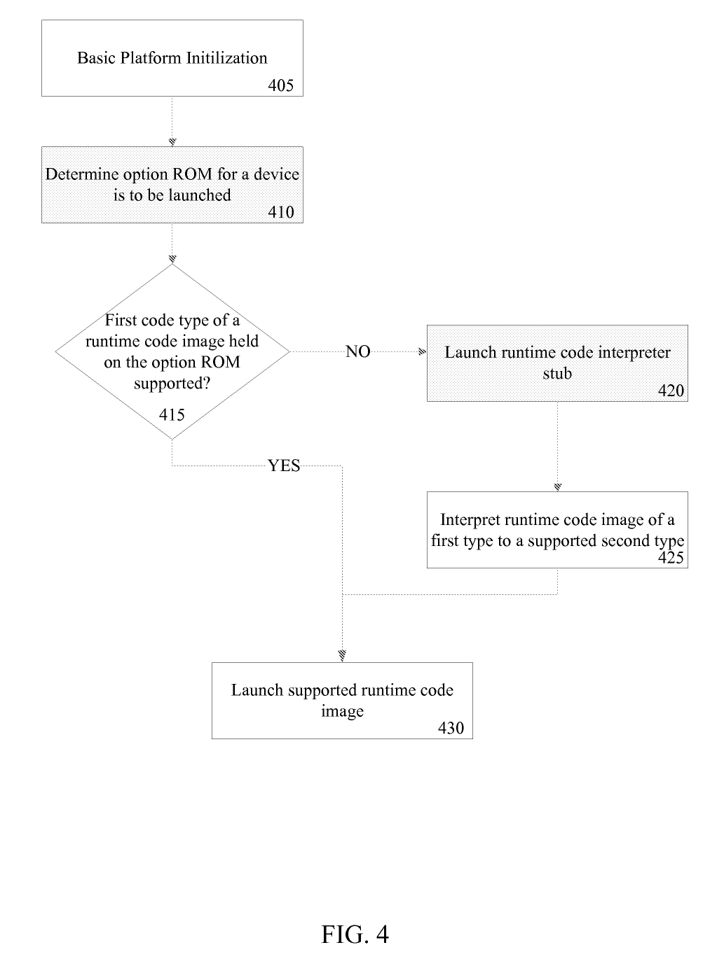

Turning to FIG. 4, an embodiment of a flow diagram for a method of launching an option ROM is illustrated. In flow 405, normal basic platform initialization is started, such as basic Power On Self Test (POST). In flow 410, it is determined if an option ROM for a device is to be launched. As an example, a device, such as an add-in card, includes a ROM potentially holding initialization and/or runtime code for the device. Therefore, for the system to recognize and interact properly with the device, the configuration space of the device including the option ROM is consulted for information and code to be executed. Consequently, when adding a device or fulfilling a service request for the device, the option ROM code/information is consulted, launched, and/or executed.

If no option ROM is to be launched, then normal basic platform initialization or operation continues. However, if an option ROM is to be launched, then it is determined if a first code type of a runtime code image held on the device's storage element, such as a ROM, is supported in flow 415. To illustrate the flow of FIG. 4, an exemplary first code type of an EFI Byte code type for the runtime code image is utilized. Here, if the EFI Byte code type is supported by the platform, i.e. EFI firmware capable of executing the EFI byte code is present in the platform, then the EFI Byte code runtime image is directly launched in flow 430 without having to launch/execute an interpreter stub.

However, if the EFI byte code type is not supported by the platform, then in flow 420 the runtime code interpreter stub is launched. In one embodiment, the code type of the interpreter stub is a generic or encompassing code type, such as an x86 code type, to provide general compatibility. However, any code type may be used for the interpreter stub.

Next, in flow 425, execution of the interpreter stub seeks out and interprets the runtime image having the first code type to a supported second code type, which results in launching of the runtime code image with the second code type in flow 430. In other words, the supported interpreter stub interprets the unsupported EBC runtime code image to launch an option ROM. As an example of translation, instructions/operations are translated from the EBC recognized instructions/operations to equivalent second code type recognized instructions/operations. Note that the runtime code image may by default having any code type, such as legacy, x86, EBC, EFI, or other code type, which is capable of being interpreted by the interpreter stub for another platform and/or firmware architecture.

As can be seen from above, instead of requiring an option ROM code image for each variation of a platform and firmware architecture, a single code image may be provided to save in space, programming/compiling time, and complexity. In addition to the single runtime code image, an interpreter stub may also be provided, which, when executed, is capable of interpreting the single code image for a different supported code type. Therefore, multiple platform, processor, and firmware architectures may be supported through execution of an interpreter, which in turn launches the single code image. As stated above, the interpreter may be capable of interpreting a code image for multiple platform/firmware architectures. In addition, a single code image may be provided with multiple interpreters to support different environmental variations without prohibitive space and complexity.

The embodiments of methods, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a device to be coupled in a computer system supporting a first code type, the device including a storage element, wherein the storage element is to hold a code image having a second code type and to hold an interpreter image, the interpreter image, when executed, to interpret the code image for the computer system supporting the first code type.

2. The apparatus of claim 1, wherein the device is further to hold additional code, when executed by the computer system, to determine if the computer system includes firmware capable of directly executing the second code type before executing the interpreter image.

3. The apparatus of claim 2, wherein in response to determining the computer system includes interpreter firmware capable of directly executing the second code type, the computer system directly executes the code image having the second code type without executing the interpreter image.

4. The apparatus of claim 1, wherein the second code type includes an Extensible Firmware Interface (EFI) code type, and wherein the first code type is selected from a group consisting of a legacy 32-bit code type, a legacy 64 bit code type, a legacy IPF code type.

5. The apparatus of claim 4, wherein the code image having an EFI code type includes EFI Byte Code (EBC), and wherein the interpreter image, when executed to interpret the code code image for the computer system includes the interpreter image, when executed, to translate the EBC to the second code type.

6. The apparatus of claim 4, wherein the code image comprises option read only memory (ROM) information.

7. The apparatus of claim 6, wherein the option (ROM) information includes a header, an image length, a code type, and runtime code.

8. The apparatus of claim 4, wherein the storage element is selected from a group consisting of a group of registers, a read only memory (ROM), a non-volatile memory, a volatile memory, and a flash device, and wherein the hardware device include an add-in card device.

9. The apparatus of claim 8, wherein the add-in card device is selected from a group consisting of a Network Interface Card (NIC), a graphics card, a graphics accelerator card, a storage device, a SCSI device, an audio card, a PCI card, a and PCI-Express Card.

10. A method comprising:
determining if a first code type of a runtime code image held in a storage element of a hardware device is supported by a computer system associated with the hardware device; and
launching an interpreter stub also held in the storage element to translate the runtime image to a second code type in response to determining the first code type of the runtime image is not supported by the computer system.

11. The method of claim 10, further comprising launching the runtime code image having the first code type without launching the interpreter stub in response to determining the first code type of the runtime image is supported by the computer system.

12. The method of claim 10, wherein the first code type is an Extensible Firmware Interface (EFI) byte code (EBC) type, and wherein determining if the first code type of the runtime image is supported comprises determining if the computer system includes EFI firmware to execute the runtime image with the EBC type.

13. The method of claim 10, wherein the interpreter stub, when launched, is capable of translating the runtime image to a plurality of code types, which includes the second code type.

14. The method of claim 13, further comprising determining the second code type is supported by the computer system based on the computer system's capable of executing the second code type in response to determining the first code type is not supported before launching the interpreter stub.

15. The method of claim 14, wherein the first code type includes an Extensible Firmware Interface Byte Code (EBC) type, and wherein the second code type is selected from a group consisting of a legacy 32-bit code type, a legacy 64 bit code type, and a legacy IPF code type.

16. The method of claim 10, wherein the hardware device includes an integrated circuit device, and wherein the storage element is also to hold configuration information for the integrated circuit device.

17. The method of claim 10, wherein the storage element includes an option Read Only Memory (ROM), and wherein the runtime code image includes a header, a data table, and runtime code.
